(19) United States
(12) Patent Application Publication
(10) Pub. No.: US 2014/0296394 A1
(43) Pub. Date: Oct. 2, 2014

(54) Adhesive Composition

(71) Applicant: 3M INNOVATIVE PROPERTIES COMPANY, St. Paul, MN (US)

(72) Inventors: Neyoshi Ishida, Tokyo (JP); Shigenori Ohashi, Tokyo (JP)

(21) Appl. No.: 14/355,798

(22) PCT Filed: Oct. 31, 2012
(86) PCT No.: PCT/US2012/062718

§ 371 Date: May 1, 2014

(30) Foreign Application Priority Data
Nov. 2, 2011 (JP) 2011-241131

(51) Int. Cl. C09J 133/04

(52) U.S. Cl. CPC C09J 133/04
USPC 524/68; 524/271; 525/206; 525/185

(57) ABSTRACT

An adhesive that displays high adhesive strength to polyolefin materials, has a curing rate that is sufficiently fast for practical use, and also displays good adhesive strength to general use materials includes a moisture curing resin composition including a copolymer having a hydrolytic silyl group, the copolymer including a (meth)acrylic acid alkylester monomer unit with an alkyl group having from 1 to 8 carbons and a (meth)acrylic acid alkylester monomer unit with an alkyl group having not less than 10 carbons, and an oxyalkylene polymer having a hydrolytic silyl group; a chlorinated polyolefin; a hydrolytic silane having not less than two phenyl groups as organic groups; and a tackifying resin that has compatibility with the moisture curing resin composition and that is solid at 25° C. wherein a content of the hydrolytic silane is more than 0 parts by mass and not more than 9 parts by mass per 100 parts by mass of the moisture curing resin composition.

### BACKGROUND

The present invention relates generally to an adhesive composition. Generally, modified silicone adhesives including a polyether polymer having a hydrolytic silyl group as a main component are used widely as elastic adhesives because they are flexible after curing and exhibit excellent adhesive strength with respect to various adherends. However, conventional modified silicone adhesives have poor adhesive properties to plastics such as polypropylene and polyethylene. Japanese Unexamined Patent Application Publication No. 2007-269935 relates to an adhesive composition with improved adhesion to such materials.

### SUMMARY

While adhesive strength with respect to polyolefin is improved through the adhesive composition described in Japanese Unexamined Patent Application Publication No. 2007-269935, curing rate is longer than that of conventional modified silicone adhesives, and conversely, adhesive strength to general purpose materials other than polyolefin is lower.

There is a need for an adhesive composition that displays high adhesive strength to polyolefin materials, has a curing rate that is sufficiently fast for practical use, and also displays good adhesion to general purpose materials.

The present invention provides an adhesive composition including: a moisture curing resin composition (A) including a copolymer (A1) having a hydrolytic silyl group, the copolymer (A1) including a (meth)acrylic acid alkylester monomer unit with an alkyl group having from 1 to 8 carbons and a (meth)acrylic acid alkylester monomer unit with an alkyl group having not less than 10 carbons, and an oxyalkylene polymer (A2) having a hydrolytic silyl group; a chlorinated polyolefin (B); a hydrolytic silane (C) having not less than two phenyl groups as organic groups; and a tackifying resin (D) that has compatibility with the moisture curing resin composition (A) and that is solid at 25° C., in which a content of the hydrolytic silane (C) is more than 0 parts by mass and not more than 9 parts by mass per 100 parts by mass of the moisture curing resin composition (A).

As used herein “(meth)acryl” refers to “acryl” or “methacryl”.

In accordance with one aspect of the invention, an adhesive composition is provided that displays high adhesive strength to polyolefin materials, a curing rate sufficiently fast for practical use, and also displays good adhesion to general purpose materials.

### BRIEF DESCRIPTION OF THE DRAWINGS

FIG. 1 is a drawing illustrating initial adhesive strength of adhesive compositions of Working Example 1 and Comparative Example 1.

### DETAILED DESCRIPTION

An embodiment of the present invention is described below in detail.

An adhesive composition according to this embodiment includes a moisture curing resin composition (A), a chlorinated polyolefin (B), a hydrolytic silane (C), and a tackifying resin (D).

Here, it is sufficient that the moisture curing resin composition (A) includes a copolymer (A1) and an oxyalkylene polymer (A2), and may include only the copolymer (A1) and the oxyalkylene polymer (A2) (hereinafter also referred to simply as “component A”). In one embodiment, the copolymer (A1) includes a (meth)acrylic acid alkylester monomer unit with an alkyl group having from 1 to 8 carbons and a (meth)acrylic acid alkylester monomer unit with an alkyl group having not less than 10 carbons as monomer units (hereinafter also referred to simply as “component A1”). In another embodiment, the oxyalkylene polymer (A2) is an oxyalkylene polymer having a hydrolytic silyl group that is the same or different from that of component A1 (hereinafter also referred to simply as “component A2”).

In one embodiment, the hydrolytic silane (C) is a hydrolytic silane having not less than two phenyl groups as organic groups (hereinafter also referred to simply as “component C”); and the tackifying resin (D) is a tackifier that has compatibility with the moisture curing resin composition (A) and that is solid at 25° C. (hereinafter also referred to simply as “component D”).

With conventional adhesive compositions such as the adhesive composition described in Japanese Unexamined Patent Application Publication No. 2007-269935, when an adhesive composition includes a hydrolytic diphenyl silane, while excellent adhesion to polyolefin is displayed, the curing rate tends to be slower than that of conventional modified silicone adhesives, and conversely, adhesive strength to general purpose materials other than polyolefin tends to be lower. It is thought that a reason for this is because the hydrolytic diphenyl silane itself uses water to react, which results in a reaction product thereof having a flexible structure and, thus, this compound invites a decline in the hardness of the adhesive cured product (a decline in adhesive strength to general purpose materials) and a reduction in the curing reaction rate of the adhesive. However, while simply reducing a compound amount of the hydrolytic diphenyl silane will result in improvements in the curing rate and the adhesive strength to general purpose materials, high adhesive strength to polyolefin materials will be lost.

It was discovered that by including the component A, the component B, the component C, in combination therewith, the tackifier (the component D) that has compatibility with the component A and is solid at 25° C., and adjusting content amount of component C to component A in the adhesive composition of the embodiment of the present invention, the curing rate can be prominently increased while maintaining high adhesion to both polyolefin materials and general purpose materials.

Detailed descriptions of each of the components included in the adhesive composition of this embodiment are given below.

First, a description of the component A1 will be given.

The component A1 has a hydrolytic silyl group, and this hydrolytic silyl group is preferably a group expressed by general formula (1) below.

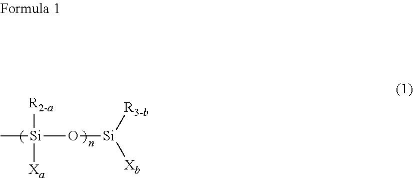

In the formula shown above, R represents a substituted or unsubstituted monovalent organic group having from 1 to 20 carbons, or a triorganosiloxy group. Examples of the organic groups described above include an alkyl group such as a methyl group, an ethyl group, a propyl group, and the like; a cycloalkyl group such as a cyclohexyl group, a cyclooctyl group, and the like; an aryl group such as a phenyl group and the like; and an aralkyl group such as a benzyl group and the like. Examples of the triorganosiloxy group described above include a trimethylsiloxy group, a triethylsiloxy group, and the like. R is preferably an unsubstituted monovalent organic group having from 1 to 6 carbons, more preferably an unsubstituted monovalent organic group having from 1 to 3 carbons, and particularly preferably a methyl group.

In the formula shown above, X represents a hydrolytic group. Examples of the hydrolytic group include a hydroxyl group; a halogen atom such as a chlorine atom and the like; an alkoxy group such as a methoxy group, an ethoxy group, a propoxy group, and the like; an acyloxy group; an amino group; an amide group; a mercapto group; an alkenyloxy group; an aminooxy group; a ketoximate group; a hydride group; and the like. Particularly, from the point of handling, the hydrolytic group is preferably a methoxy group or an ethoxy group.

In the formula shown above, a is 0, 1, or 2, and b is 0, 1, 2, or 3; a and b are not both 0 simultaneously. n represents an integer from 0 to 18. Particularly, from the point of economic efficiency, preferably n=0 and b=1, 2, or 3.

The component A1 is a copolymer including a (meth)acrylic acid alkylester monomer unit with an alkyl group having from 1 to 8 carbons (hereinafter also referred to as a “low alkyl acrylic monomer unit”) and a (meth)acrylic acid alkylester monomer unit with an alkyl group having not less than 10 carbons (hereinafter also referred to as a “high alkyl acrylic monomer unit”) as monomer units; and preferably further includes a monomer unit having an ethylenically unsaturated bond and a hydrolytic silyl group (preferably a product expressed by general formula (1) above). In other words, the hydrolytic silyl group is preferably derived from a monomer unit other than the low alkyl acrylic monomer unit and the high alkyl acrylic monomer unit.

In such a case, the component A1 can be obtained by copolymerizing a (meth)acrylic acid alkylester that provides the low alkyl acrylic monomer unit, an alkyl group thereof having from 1 to 8 carbons; a (meth)acrylic acid alkylester that provides the high alkyl acrylic monomer unit, an alkyl group thereof having not less than 10 carbons; and the monomer having the ethylenically unsaturated bond and the hydrolytic silyl group (preferably the product expressed by general formula (1) above) (synthesis method 1). Additionally, the component A1 can be synthesized by a method wherein a (meth)acrylic acid alkylester that provides the low alkyl acrylic monomer unit, an alkyl group thereof having from 1 to 8 carbons; a (meth)acrylic acid alkylester that provides the high alkyl acrylic monomer unit, an alkyl group thereof having not less than 10 carbons; and the monomer having the ethylenically unsaturated bond and a functional group Y are copolymerized; and, thereafter, a compound including a functional group Y′ that has reactivity with the functional group Y, and the hydrolytic silyl group are further reacted (synthesis method 2). Examples of combinations of the functional groups Y and Y′ include those where one is carboxylic acid and the other is an isocyanate group.

Examples of the low alkyl acrylic monomer unit include products expressed by general formula (2) below.

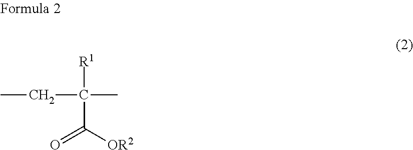

In the formula above, R′ represents hydrogen or a methyl group, and R² represents an alkyl group having from 1 to 8 carbons. Specifically, examples of R² include a methyl group having 1 carbon, an ethyl group having 2 carbons, a propyl group having 3 carbons, an n-butyl group and a t-butyl group having 4 carbons, a 2-ethylhexyl group having 8 carbons, and the like. Particularly, R² is preferably an alkyl group having from 1 to 4 carbons, and more preferably an alkyl group having from 1 to 2 carbons. Note that the R² alkyl group may be a single alkyl group or a mixture of two or more types of alkyl groups.

Examples of the high alkyl acrylic monomer unit include products expressed by general formula (3) below.

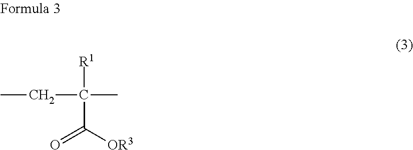

In the formula above, R′ is the same as in the general formula (2). R³ represents an alkyl group having not less than 10 carbons. Specifically, examples of R³ include a lauryl group having 12 carbons, a tridecyl group having 13 carbons, a cetyl group having 16 carbons, a stearyl group having 18 carbons, a behenyl group having 22 carbons, and the like. An alkyl group having from 10 to 30 carbons is commonly selected as R³, and preferably an alkyl group having from 10 to 20 carbons is selected. Note that the R³ alkyl group may be a single alkyl group or a mixture of two or more types of alkyl groups.

A total of the low alkyl acrylic monomer unit and the high alkyl acrylic monomer unit with respect to all of the monomer units constituting the component A1 preferably exceeds 50 weight %, and more preferably is not less than 70 weight %. Additionally, a ratio (weight ratio) of the alkyl acryl monomer unit to the high alkyl acrylic monomer unit is preferably such that former:latter is from 95:5 to 40:60, and more preferably such that former:latter is from 90:10 to 60:40.

When using the synthesis method 1 described above, the following are examples of the monomer having the ethylenically unsaturated bond and the hydrolytic silyl group: CH₂═CHSiCH₃(OCH₃)₂, CH₂═CHSiCH₃Cl₂, CH₂═CHSi(OCH₃)₃, CH₂═CHCOO(CH₂)₂SiCH₃(OCH₃)₂, CH₂═CHCOO(CH₂)₂Si(OCH₃)₃, CH₂═CHCOO(CH₂)₃SiCH₃(OCH₃)₂, CH₂═CHCOO(CH₂)₃Si(OCH₃)₃, CH₂═C(CH₃)COO(CH₂)₂SiCH₃(OCH₃)₂, CH₂═C(CH₃)COO(CH₂)₂Si(OCH₃)₃, CH₂═C(CH₃)COO(CH₂)₃SiCH₃(OCH₃)₂, CH₂═C(CH₃)COO(CH₂)₃Si(OCH₃)₃, and the like.

The component A1 may further include a monomer unit in addition to those described above. Examples of such a monomer unit include monomer units including carboxylic acid such as (meth)acrylic acid and the like; monomer units including an amide group such as (meth)acrylamide, N-methylol(meth)acrylamide, and the like; monomer units including an epoxy group such as glycidyl(meth)acrylate and the like; monomer units including an amino group such as diethylaminoethyl(meth)acrylate, amino ethyl vinyl ether, and the like; and monomer units derived from acrylonitrile, iminol methacrylate, styrene, α-methylstyrene, alkyl vinyl ether, vinyl chloride, vinyl acetate, vinyl propionate, ethylene, and the like.

From the point of handling, a number-average molecular weight of the component A1 is preferably from 500 to 100,000. Additionally, a number of the hydrolytic silyl groups in the component A1 is selected from the point of curability and is, on average, not less than 1, preferably not less than 1.1, and more preferably not less than 1.5. Moreover, with respect to appearance, a number-average molecular weight per one silyl group is preferably from 3,000 to 4,000. The component A1 can, for example, be fabricated according to the process described in Japanese Unexamined Patent Application No. S63-112642, or the like.

Next, a description of the component A2 will be given.

A molecular skeleton of the oxyalkylene polymer having the hydrolytic silyl group, which is the component A2, can, for example, be expressed by general formula (4) below.

Formula 4

R⁵—Oₙ (4)

In the formula above, R⁵ is a divalent organic group. Particularly, R⁵ is preferably a hydrocarbon group having from 3 to 4 carbons. Examples of R⁵ include a methyl-ethenyl group, an ethyl-ethenyl group, an isobutenyl group, a butenyl group, and the like. This molecular skeleton may be only one type of iteration unit or maybe two or more types of iterating units. Particularly, R⁵ has a polyoxypropylene skeleton that is a methyl-ethenyl group.

The hydrolytic silyl group in the component A2 is the same as the hydrolytic silyl group in the component A1. Additionally, from the point of curability, a number of the hydrolytic silyl groups in the component A2 present on an end of the molecule is, on average, preferably not less than 1, more preferably not less than 1.1, and particularly preferably not less than 1.5. A number-average molecular weight of the component A2 is preferably from 500 to 30,000. The component A2 may be a single component or a mixture of multiple components. The component A2 can, for example, be fabricated according to the process described in Japanese Unexamined Patent Application No. S63-112642, or the like.

Next, a description of the component A will be given.

A moisture curing resin composition that is the component A includes the component A1 and the component A2 described above. However, the component A may be obtained by individually synthesizing the component A1 and the component A2 and thereafter mixing these or, alternately, by synthesizing one of the component A1 and the component A2, mixing that synthesized product with the other raw material monomer and, in said mixed state, polymerizing said raw material monomer.

Additionally, a ratio of the component A1 and the component A2 is preferably from 0.5 to 5,000 parts by mass and particularly preferably from 0.5 to 2,000 parts by mass of the component A1 per 100 parts by mass of the component A2.

Next, a description of the component B will be given.

Examples of a chlorinated polyolefin that is the component B include chlorinated products of polyolefins. Examples thereof include chlorinated products such as polyethylene, polypropylene, polybutene, and other CS-based α-olefin polymers; poly(4-methylpenta-1-ene), an ethylene-propylene copolymer, a propylene-butene copolymer, an ethylene-propylene-butene ternary copolymer, and other α-olefin copolymers; copolymers of α-olefin and not more than 50% of another monomer (e.g. an ethylene-vinyl acetate copolymer, an ethylene-ethyl acrylate copolymer, an ethylene-maleic anhydride copolymer, an ethylene-ethyl acrylate-maleic anhydride ternary copolymer, and the like); and the like. A chlorinated product of a low olefin polymer having from 2 to 5 carbons is particularly preferable. Examples thereof include chlorinated products of polyethylene, polypropylene, polybutene, and the like.

A ratio of chlorine included in these chlorinated polyolefins is preferably from 5 to 60 weight %, and more preferably from 10 to 45 weight %. Additionally, an added amount of the chlorinated polyolefin is preferably from 0.1 to 100 parts by mass per 100 parts by mass of the component A that includes the component A1 and the component A2.

Next, a description of the component C will be given.

A hydrolytic silane having not less than two phenyl groups as organic groups that is the component C is, for example, expressed by general formula (5) below.

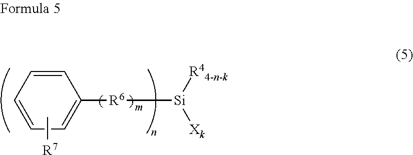

In the formula above, X and R⁴ are the same as the X and R⁴ described above, respectively. R⁶ represents a divalent organic group. R⁷ represents hydrogen or an organic group. Examples of the organic group include a vinyl group and the like. If R⁷ is an organic group, it may be substituted at any of the ortho, meta, or para positions. n and k are 1, 2, or 3, and respectively represent integers such that n+k is not more than 4. m represents 0 or 1.

Examples of the component C include a diphenyldimethoxysilane (where X═OCH₃, R⁷═H, n=2, k=2, and m=0), a phenyltrimethoxysilane (where X═OCH₃, R⁷═H, n=1, k=3, and m=0), a phenyltriethoxysilane (where X═OC₂H₅, R⁷═H, n=1, k=3, and m=0), a 3-styrylpropyltrimethoxysilane (where X═OCH₃, R⁷═CHCH₂, R⁶═CH₂CH₂CH₂, n=1, k=3, and m=1), an N-phenyl-3-aminopropyltrimethoxysilane (where X═OCH₃, R⁷═H, R⁶═NHCH₂CH₂CH₂, n=1, k=3, and m=1), and the like.

An added amount of the component C is preferably more than 0 parts by mass and not more than 9 parts by mass and more preferably not less than 1 part by mass and not more than 6 parts by mass per 100 parts by mass of the component A that includes the component A1 and the component A2. By configuring the added amount in this way, the adhesive composition keep high adhesive strength to polyolefin materials and have a curing rate sufficiently fast for practical use,

Next, a description of the component D will be given.

The component D is a tackifying resin that has compatibility with the component A and is a solid at 25° C. Here, “compatibility” can be determined by the transparency of a mixture obtained by mixing the component D and the component A. When the mixture is transparent, it is determined that there is compatibility, and when the mixture is non-transparent, it is determined that there is not compatibility. Specifically, the mixture is prepared by kneading and dewatering 100 g of the component A and 10 g of the component D by agitating in vacuo for two hours at 130° C.; and, following cooling, adding 5 g of a tin-based catalyst to the mixture. Then, the mixture is coated on a glass plate and transparency is visually confirmed. The component D is a solid at 25° C., which is a temperature included in a range of practical use temperatures. Cases when the component D is a liquid or fluid at 25° C. will lead to a decline in the cohesion of the cured product of the adhesive and, thus, a decline in adhesive strength.

The component D is preferably at least one resin selected from the group consisting of rosin ester resin, terpene phenol resin, aromatic-based petroleum resin, and coumarone-based resin. Such a tackifying resin has superior compatibility with the component A; and an adhesive composition containing such displays sufficient adhesive strength to both polyolefin materials and general purpose materials and also displays a superior curing rate.

Examples of the rosin ester resin include Ester Gum H, Ester Gum Hp, Ester Gum AAG, Super Ester A100, Super Ester A115, and Pine Crystal KE-311 (all manufactured by Arakawa Chemical Industries, Ltd.); and Foral 85, Foral 105, and Staybelite Ester (all manufactured by Eastman Chemical Company).

Examples of the terpene phenol resin include YS Polystar T-80, YS Polystar T-100, YS Polystar T-115, YS Polystar T-130, YS Polystar T-145, YS Polystar S-145, YS Polystar #2100, and YS Polystar #2300 (all manufactured by Yasuhara Chemical Co., Ltd.).

Examples of the aromatic-based petroleum resin include resins having a skeleton expressed by general formula (6) below.

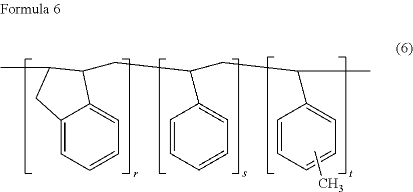

In the formula above, s is an integer not less than 1, r is 0 or an integer not less than 1, and t is 0 or an integer not less than 1. Examples of such a aromatic-based petroleum resin include FTR8120, Tack Ace A-100, and Tack Ace F-100 (all manufactured by Mitsui Chemicals, Inc.); Picolastic A75 (manufactured by Eastman Chemical Company); and the like.

Examples of the coumarone-based resin include resins having a skeleton expressed by general formula (7) below.

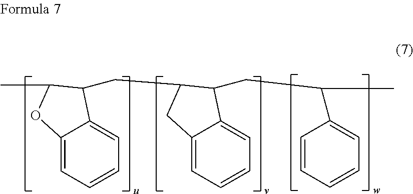

In the formula above, u is 0 or an integer not less than 1, v is 0 or an integer not less than 1, and w is 0 or an integer not less than 1. However, u and v are not 0 simultaneously. Examples of such a coumarone-based resin include Nitto Resin Coumarone G-90, Nitto Resin Coumarone G-100N, Nitto Resin Coumarone V-120, Nitto Resin Coumarone V-120S (all manufactured by Nitto Chemical Co., Ltd.), and the like.

An added amount of the component D is preferably not less than 1 part by mass and not more than 200 parts by mass per 100 parts by mass of the component A that includes the component A1 and the component A2. Additionally, a total content of the component B and the component D is preferably more than 5 parts by mass and not more than 200 parts by mass, more preferably not less than 5 parts by mass and not more than 100 parts by mass, and even more preferably not less than 5 parts by mass and not more than 50 parts by mass per 100 parts by mass of the component A. By configuring the total content of the component B and the component D with respect to the component A to be in such a range, adhesive strength to polyolefin materials and adhesive strength to general purpose materials is even more superior. A mass ratio of the component D to the component B(component D/component B) is preferably not less than 0.1 and not more than 10, is more preferably not less than 0.2 and not more than 8, and is even more preferably not less than 0.3 and not more than 5. By configuring the mass ratio of the component D to the component B to be in such a range, compatibility of the chlorinated polyolefin can be enhanced, and adhesive strength to polyolefin can be maintained at a high level. If the total content of the component B and the component D is less than 5 parts by mass, adhesive strength to polyolefin materials will tend to decrease; and if the total content exceeds 200 parts by mass, adhesive viscosity will increase and handling may become difficult. If component D/component B is less than 0.1, the curing rate will tend to decrease; and if component D/component B exceeds 10, adhesive strength to polyolefin materials may decrease.

The adhesive composition may also include other components other than the component A, the component B, the component C, and the component D described above.

Examples of such components include silane coupling agents (hydrolytic silane having an organic group); and silane coupling agents having an organic group containing a glycidyl group, a methacryloxy group, a mercapto group, or an amino group can be applied. A silane coupling agent having an amino group (hydrolytic silane having an amino group) is preferable as the silane coupling agent. Such a silane coupling agent can, for example, be expressed by general formula (8) below. By including such a silane coupling agent, particularly a hydrolytic silane having an amino group, curing is promoted and adhesive strength to general purpose materials is enhanced.

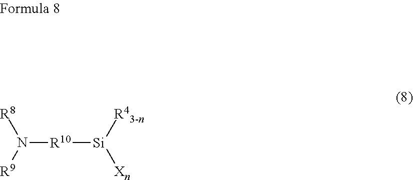

In the formula above, R⁸ and R⁹ represent hydrogen or organic groups. Examples of the organic groups include alkyl groups such as a methyl group and the like; aryl groups such as a phenyl group and the like; alkyl group having a substituent such as aminoethyl and the like; and the like. R⁸ and R⁹ may be the same or different. R¹⁰ is a divalent organic group. R⁴ and X are the same as the R⁴ and the X described above. n is 1, 2, or 3. Examples of the hydrolytic silane include 3-aminopropyltrimethoxysilane (where R⁸═R⁹═H, R¹⁰═CH₂CH₂CH₂, X═OCH₃, n=3), N-(2-aminoethyl)3-aminopropyltrimethoxysilane (R⁸═H, R⁹═H₂NCH₂CH₂, R¹⁰═CH₂CH₂CH₂, X═OCH₃, n=3), and the like.

An added amount of the silane coupling agent is preferably not less than 0.1 parts by mass and not more than 50 parts by mass, and more preferably not less than 1 part by mass and not more than 20 parts by mass per 100 parts by mass of the component A that includes the component A1 and the component A2.

Additionally, a curing catalyst, a filler, a diluent, a dewatering agent, an antiaging agent, a thixotropic agent, an UV light absorber, a light stabilizer, and the like may be added to the adhesive composition.

Examples of known curing catalysts for modified silicone resin that can be used as the curing catalyst include organic tin, inorganic tin, organic titanate, amine, phosphate ester, reaction products of phosphate ester and amine, polyvalent carboxylic acid, polyvalent carboxylic acid anhydride, and the like.

Examples of known fillers that can be used as the filler include calcium carbonate, talc, clay, carbon black, silica, titanium oxide, aluminum silicate, aluminum hydroxide, magnesium hydroxide, magnesium oxide, zinc oxide, glass filler, organic powders, various balloons, and the like.

Examples of known diluents that can be used as the diluent include phthalic acid ester, polyoxyalkylene, and the like. Examples of known dewatering agents that can be used as the dewatering agent include vinylalkoxysilane, alkylalkoxysilane, orthosilicate, anhydrous sodium sulfate, zeolite, and the like.

The adhesive composition described above has rapid curing properties, and has superior adhesion to polyolefin, and therefore can be used as a rapid curing adhesive agent for adhering polyolefin materials. Note that it is possible to treat a polyolefin material (adherend) with a primer before adhering, but as long as the adhesive composition of the present invention is being used, priming can be omitted.

### EXAMPLES

The present invention will be explained in further detail below based on working examples and comparative examples, but the present invention is not limited whatsoever to the following working examples.

### Compatibility of the Tackifier, Solid Properties

Compatibility of the component D with the component A was confirmed as described below.

100 g of Silyl MA440 (manufactured by Kaneka Corp., component A) and 10 g of a tackifier (component D) were each added to a rotary-revolutionary mixer, and kneaded and dewatered by mixing in vacuo for two hours at 130° C. After cooling, a resin composition was prepared by adding 5 g of SCat-27 (manufactured by Nitto Kasei Co., Ltd.; dibutyl dimethoxy tin) to the mixture. The resin composition was coated on a glass plate and transparency was visually confirmed. When transparency was displayed, compatibility was considered to be excellent, and when cloudiness or lack of transparency was displayed, the non-compatibility was determined The results are shown in Table 1 below.

Note that the tackifiers that were used were each solid at 25° C. Whether the tackifiers were solid or not was determined visually.

TABLE 1

| | | | Form of the |
|---|---|---|---|
| | | | tackifier at |
| Tackifier | | Compatibility | 25° C. |
| A: FTR8120 | Styrene resin (manufactured by Mitsui | Compatible | Solid |
| | Chemicals, Inc.) | | |
| B: YS Polystar T-100 | Terpene phenol resin (manufactured by | Compatible | Solid |
| | Yasuhara Chemical Co., Ltd.) | | |
| C: Picolastic A75 | Styrene resin (manufactured by Eastman | Compatible | Solid |
| | Chemical Company) | | |
| D: Nitto Resin | Coumarone resin (manufactured by Nitto | Compatible | Solid |
| Coumarone G-90 | Chemical Co., Ltd.) | | |
| E: Ester Gum H | Rosin ester resin (manufactured by | Compatible | Solid |
| | Arakawa Chemical Industries, Ltd.) | | |
| F: Arkon P-85 | Alicyclic saturated hydrocarbon resin | Non- | Solid |
| | (manufactured by Arakawa Chemical | compatible | |
| | Industries, Ltd.) | | |
| G: YS Resin PX-1000 | Terpene resin (manufactured by Yasuhara | Non- | Solid |
| | Chemical Co., Ltd.) | compatible | |
| H: YS Resin TO-115 | Aromatic modified terpene resin | Non- | Solid |
| | (manufactured by Yasuhara Chemical Co., | compatible | |
| | Ltd.) | | |

### Adhesion to Polypropylene

Adhesive compositions of Working Examples 1 to 5 (Table 2) and Comparative Examples 1 to 10 (Tables 3 and 4) were used to adhere a polypropylene plate to a cotton duck. After curing at room temperature for seven days, a tensile tester was used to measure 180 degree pealing strength (N/25 mm) by pulling the cotton duck in a 180 degree direction at a speed of 50 mm/minute.

### Adhesive Strength

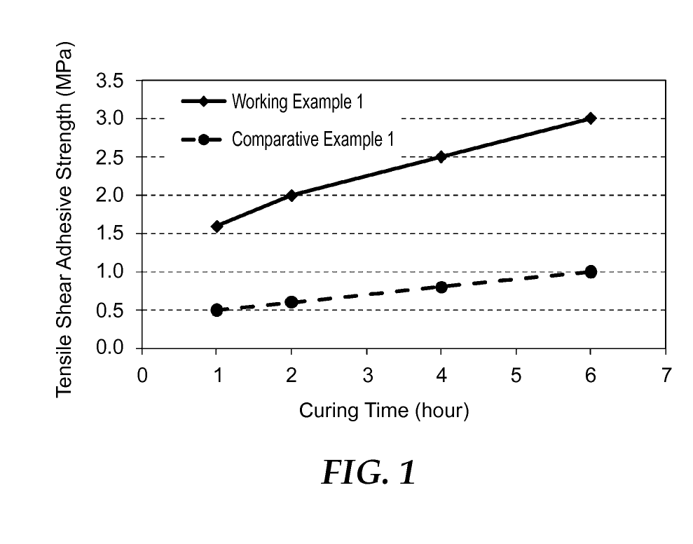

Plywood boards were adhered together using the adhesive compositions of Working Examples 1, and Comparative Examples 1. After curing at room temperature for one, two, four, and six hours, a tensile tester was used to measure a tensile shear strength (MPa) by pulling in a shearing direction at a speed of 50 mm/minute (FIG. 1). Adhesive compositions of Working Examples 1 to 6 (Table 2) and Comparative Examples 1 to 11 (Table 3) were used to adhere plywood boards together. After curing at room temperature, a tensile tester was used to measure a tensile shear strength (MPa) by pulling in a shearing direction at a speed of 50 mm/minute. The adhesive strength after four hours of curing was considered as initial adhesive strength, and was considered as an indicator of the curing rate (higher initial adhesive strength indicates a faster curing rate). Additionally, adhesive strength after seven days of curing was considered as final adhesive strength.

### Working Example 1

100 g of Silyl MA440, 75 g of Vigot-10 (manufactured by Shiraishi Kogyo Kaisha, Ltd.; calcium carbonate), 5 g of Superchlon 814HS (manufactured by Nippon Paper Chemicals; chlorinated polypropylene), and 3 g of FTR8120 (tackifier A) were each added to a rotary-revolutionary mixer, and kneaded and dewatered by mixing in vacuo for two hours at 130° C. After cooling, an adhesive composition was prepared by adding each of 2 g of Ethyl Silicate 28 (manufactured by Coalcoat Co., Ltd.; tetraethoxysilane), 3 g of KBM202SS (manufactured by Shin-Etsu Chemical Co., Ltd.; diphenyl dimethoxysilane), 5 g of KBM603 (manufactured by Shin-Etsu Chemical Co., Ltd.; N-(2-aminoethyl)3-aminopropyltrimethoxysilane), and 5 g of SCat-27 (manufactured by Nitto Kasei Co., Ltd.; dibutyl dimethoxy tin) to the mixture.

### Working Example 2

100 g of Silyl MA440, 75 g of Vigot-10, 5 g of Superchlon 814HS, and 10 g of YS Polystar T-100 (tackifier B) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Working Example 3

100 g of Silyl MA440, 75 g of Vigot-10, 5 g of Superchlon 814HS, and 10 g of Picolastic A75 (tackifier C) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Working Example 4

100 g of Silyl MA440, 75 g of Vigot-10, 5 g of Superchlon 814HS, and 10 g of Nitto Resin Coumarone G-90 (tackifier D) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Working Example 5

100 g of Silyl MA440, 75 g of Vigot-10, 5 g of Superchlon 814HS, and 10 g of Ester Gum H (tackifier E) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Working Example 6

100 g of Silyl MA440, 75 g of Vigot-10, 5 g of Superchlon 814HS, and 3 g of FTR8120 (tackifier A) were each added to a rotary-revolutionary mixer, and kneaded and dewatered by mixing in vacuo for two hours at 130° C. After cooling, an adhesive composition was prepared by adding each of 2 g of Ethyl Silicate 28, 6 g of KBM202SS, 5 g of KBM603, and 5 g of SCat-27 to the mixture.

### Comparative Example 1

An adhesive composition not including the tackifier (component D) was fabricated as described below.

100 g of Silyl MA440, 75 g of Vigot-10, and 5 g of Superchlon 814HS were each added to a rotary-revolutionary mixer, and kneaded and dewatered by mixing in vacuo for two hours at 120° C. After cooling, an adhesive composition was prepared by adding each of 2 g of Ethyl Silicate 28, 9 g of KBM202SS, 5 g of KBM603, and 5 g of SCat-27 to the mixture.

### Comparative Example 2

An adhesive composition not including the tackifier (component D) was fabricated as described below.

100 g of Silyl MA440, 75 g of Vigot-10, and 5 g of Superchlon 814HS were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 3

An adhesive composition was fabricated to which the tackifier (component D) was added under the conditions that the chlorinated polyolefin (component B) and the hydrolytic silane (component C) were not included.

100 g of Silyl MA440, 75 g of Vigot-10, and 10 g of FTR8120 (tackifier A) were each added to a rotary-revolutionary mixer, and kneaded and dewatered by mixing in vacuo for two hours at 130° C. After cooling, an adhesive composition was prepared by adding each of 2 g of Ethyl Silicate 28, 5 g of KBM603, and 5 g of SCat-27 to the mixture.

### Comparative Example 4

An adhesive composition was fabricated to which the tackifier (component D) was added under the conditions that the chlorinated polyolefin (component B) and the hydrolytic silane (component C) were not included.

100 g of Silyl MA440, 75 g of Vigot-10, and 20 g of FTR8120 (tackifier A) were each added to a rotary-revolutionary mixer, and kneaded and dewatered by mixing in vacuo for two hours at 130° C. After cooling, an adhesive composition was prepared by adding each of 2 g of Ethyl Silicate 28, 5 g of KBM603, and 5 g of SCat-27 to the mixture.

### Comparative Example 5

An adhesive composition including a tackifier (component D) that does not have compatibility with the component A was fabricated as described below.

100 g of Silyl MA440, 75 g of Vigot-10, 5 g of Superchlon 814HS, and 3 g of Arkon P-85 (tackifier F) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 6

An adhesive composition including a tackifier (component D) that does not have compatibility with the component A was fabricated as described below.

100 g of Silyl MA440, 75 g of Vigot-10, 5 g of Superchlon 814HS, and 10 g of Arkon P-85 (tackifier F) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 7

An adhesive composition including a tackifier (component D) that does not have compatibility with the component A was fabricated as described below.

100 g of Silyl MA440, 75 g of Vigot-10, 5 g of Superchlon 814HS, and 3 g of YS Resin PX-1000 (tackifier G) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 8

An adhesive composition including a tackifier (component D) that does not have compatibility with the component A was fabricated as described below.

100 g of Silyl MA440, 75 g of Vigot-10, 5 g of Superchlon 814HS, and 10 g of YS Resin PX-1000 (tackifier G) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 9

An adhesive composition including a tackifier (component D) that does not have compatibility with the component A was fabricated as described below.

100 g of Silyl MA440, 75 g of Vigot-10, 5 g of Superchlon 814HS, and 3 g of YS Resin TO-115 (tackifier H) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 10

An adhesive composition including a tackifier (component D) that does not have compatibility with the component A was fabricated as described below.

100 g of Silyl MA440, 75 g of Vigot-10, 5 g of Superchlon 814HS, and 10 g of YS Resin TO-115 (tackifier H) were each added to a rotary-revolutionary mixer, and kneaded and dewatered by mixing in vacuo for two hours at 120° C. After cooling, an adhesive composition was prepared by adding each of 2 g of Ethyl Silicate 28, 3 g of KBM202SS, 5 g of KBM603, and 5 g of SCat-27 to the mixture.

### Comparative Example 11

100 g of Silyl MA440, 75 g of Vigot-10, 5 g of Superchlon 814HS, and 3 g of FTR8120 (tackifier A) were each added to a rotary-revolutionary mixer, and kneaded and dewatered by mixing in vacuo for two hours at 130° C. After cooling, an adhesive composition was prepared by adding each of 2 g of Ethyl Silicate 28, 9 g of KBM202SS, 5 g of KBM603, and 5 g of SCat-27 to the mixture.

PP adhesion (N/25 mm) and initial and final adhesive strength (MPa) for Working Examples 1 to 6 are shown in Table 2 below. PP adhesion (N/25 mm) and initial adhesive strength (MPa) for Comparative Examples 1 to 11 are shown in Tables 3 and 4 below.

TABLE 2

| | Working | Working | Working | Working | Working | Working |
|---|---|---|---|---|---|---|
| | Example 1 | Example 2 | Example 3 | Example 4 | Example 5 | Example 6 |
| Resin | 100 | 100 | 100 | 100 | 100 | 100 |
| Filler | 75 | 75 | 75 | 75 | 75 | 75 |
| Chlorinated | 5 | 5 | 5 | 5 | 5 | 5 |
| polyolefin | | | | | | |
| Tackifier A | 3 | — | — | — | — | 3 |
| Tackifier B | — | 10 | — | — | — | — |
| Tackifier C | — | — | 10 | — | — | — |
| Tackifier D | — | — | — | 10 | — | — |
| Tackifier E | — | — | — | — | 10 | — |
| Dewatering agent | 2 | 2 | 2 | 2 | 2 | 2 |
| Phenylsilane | 3 | 3 | 3 | 3 | 3 | 6 |
| Aminosilane | 5 | 5 | 5 | 5 | 5 | 5 |
| Catalyst | 5 | 5 | 5 | 5 | 5 | 5 |
| PP adhesion | 114 | 122 | 119 | 148 | 138 | 103 |
| (N/25 mm) | | | | | | |
| Initial adhesive | 2.4 | 2.3 | 2.2 | 2.2 | 2.0 | 1.6 |
| strength (MPa) | | | | | | |
| Final adhesive | 4.1 | 4.1 | 3.6 | 4.2 | 3.6 | 3.9 |
| strength (MPa) | | | | | | |

TABLE 3

| | Compar- | Compar- | Compar- | Compar- | Compar- |
|---|---|---|---|---|---|
| | ative | ative | ative | ative | ative |
| | Example 1 | Example 2 | Example 3 | Example 4 | Example 5 |
| Resin | 100 | 100 | 100 | 100 | 100 |
| Filler | 75 | 75 | 75 | 75 | 75 |
| Chlorinated | 5 | 5 | — | — | 5 |
| polyolefin | | | | | |
| Tackifier A | — | — | 10 | 20 | — |
| Tackifier F | — | — | — | — | 3 |
| Tackifier G | — | — | — | — | — |
| Tackifier H | — | — | — | — | — |
| Dewatering | 2 | 2 | 2 | 2 | 2 |
| agent | | | | | |
| Phenylsilane | 9 | 3 | — | — | 3 |
| Aminosilane | 5 | 5 | 5 | 5 | 5 |
| Catalyst | 5 | 5 | 5 | 5 | 5 |
| PP adhesion | 111 | 34 | 9 | 8 | 13 |
| (N/25 mm) | | | | | |
| Initial | 0.8 | 2.2 | 2.8 | 3.3 | 2.4 |
| adhesive | | | | | |
| strength | | | | | |
| (MPa) | | | | | |
| Final | 2.6 | 4.2 | 4.8 | 4.1 | 3.6 |
| adhesive | | | | | |
| strength | | | | | |
| (MPa) | | | | | |

Notes:
Resin: Silyl MA440; Filler: Vigot-10; Chlorinated polyolefin: Superchlon 814HS; Tackifier A: FTR8120 (styrene resin); Tackifier F: Arkon P-85 (alicyclic saturated hydrocarbon resin); Tackifier G: YS Resin PX-1000 (terpene resin); Tackifier H: YS Resin TO-115 (aromatic modified terpene resin); Dewatering agent: Ethyl Silicate 28; Phenylsilane: KBM202SS; Aminosilane: KBM603; Catalyst: SCat-27

TABLE 4

| | Comparative | Comparative | Comparative | Comparative | Comparative | Comparative |
|---|---|---|---|---|---|---|
| | Example 6 | Example 7 | Example 8 | Example 9 | Example 10 | Example 11 |
| Resin | 100 | 100 | 100 | 100 | 100 | 100 |
| Filler | 75 | 75 | 75 | 75 | 75 | 75 |
| Chlorinated | 5 | 5 | 5 | 5 | 5 | 5 |
| polyolefin | | | | | | |
| Tackifier A | — | — | — | — | — | 3 |
| Tackifier F | 10 | — | — | — | — | — |
| Tackifier G | — | 3 | 10 | — | — | — |
| Tackifier H | — | — | — | 3 | 10 | — |
| Dewatering | 2 | 2 | 2 | 2 | 2 | — |
| agent | | | | | | |
| Phenylsilane | 3 | 3 | 3 | 3 | 3 | 2 |
| Aminosilane | 5 | 5 | 5 | 5 | 5 | 9 |
| Catalyst | 5 | 5 | 5 | 5 | 5 | 5 |
| PP adhesion | 18 | 22 | 16 | 54 | 25 | 5 |
| (N/25 mm) | | | | | | |
| Initial adhesive | 2.1 | 2.2 | 2.2 | 2.6 | 2.2 | 110 |
| strength (MPa) | | | | | | |
| Final adhesive | 3.5 | 3.6 | 3.3 | 3.5 | 3.6 | 1.0 |
| strength (MPa) | | | | | | |

Notes:
Resin: Silyl MA440; Filler: Vigot-10; Chlorinated polyolefin: Superchlon 814HS; Tackifier A: FTR8120 (styrene resin); Tackifier F: Arkon P-85 (alicyclic saturated hydrocarbon resin); Tackifier G: YS Resin PX-1000 (terpene resin); Tackifier H: YS Resin TO-115 (aromatic modified terpene resin); Dewatering agent: Ethyl Silicate 28; Phenylsilane: KBM202SS; Aminosilane: KBM603; Catalyst: SCat-27 2.4

1. An adhesive composition comprising:
a moisture curing resin composition including
a copolymer having a hydrolytic silyl group, the copolymer including a (meth)acrylic acid alkylester monomer unit with an alkyl group having from 1 to 8 carbons and a (meth)acrylic acid alkylester monomer unit with an alkyl group having not less than 10 carbons; and
an oxyalkylene polymer having a hydrolytic silyl group;
a chlorinated polyolefin;
a hydrolytic silane having not less than two phenyl groups as organic groups; and
a tackifying resin that has compatibility with the moisture curing resin composition and that is solid at 25° C.,
wherein a content of the hydrolytic silane is more than 0 parts by mass and not more than 9 parts by mass per 100 parts by mass of the moisture curing resin composition.

2. The adhesive composition according to claim 1, wherein
a total content of the chlorinated polyolefin and the tackifying resin is not less than 5 parts by mass and not more than 200 parts by mass per 100 parts by mass of the moisture curing resin composition, and
a mass ratio of the tackifying resin with respect to the chlorinated polyolefin is not less than 0.1 and not more than 10.

3. The adhesive composition according to claim 1, wherein the tackifying resin is at least one resin selected from the group consisting of a rosin ester resin, a terpene phenol resin, an aromatic-based petroleum resin, and a coumarone-based resin.

4. The adhesive composition according to claim 1, further comprising a hydrolytic silane having an amino group.

5. The adhesive composition according to claim 4, wherein a content of the hydrolytic silane having an amino group is not less than 0.1 parts by mass and not more than 50 parts by mass per 100 parts by mass of the moisture curing resin composition.

6. The adhesive composition according to claim 1, wherein a 180 degree pealing strength measured is not less than 80N/25 mm when the 180 degree pealing strength is measured by adhering a polypropylene plate to a cotton duck with the adhesive composition, curing the adhered one at room temperature for seven days and then pulling the cotton duck in a 180 degree direction at a speed of 50 mm/minutes.

7. The adhesive composition according to claim 1, wherein a first tensile shear strength is not less than 1.5 MPa when the first tensile shear strength is measured by adhering plywoods together with the adhesive composition, curing at room temperature for four hours and then pulling in a shearing direction at a speed of 50 mm/minute, and a second tensile shear strength is not less than 3 MPa when the second tensile shear strength is measured by adhering plywoods together with the adhesive composition, curing at room temperature for seven days and then pulling in a shearing direction at a speed of 50 mm/minute.
